(19) United States
(12) Patent Application Publication
(10) Pub. No.: US 2026/0241560 A1
(43) Pub. Date: Aug. 20, 2026

(54) MOTOR CONTROLLER, POSITIONING APPARATUS, AND MOTOR CONTROL METHOD

(71) Applicant: MITSUBISHI ELECTRIC CORPORATION, Tokyo (JP)

(72) Inventors: Hiroyuki SEKIGUCHI, Tokyo (JP); Ko KOSAKA, Tokyo (JP)

(73) Assignee: MITSUBISHI ELECTRIC CORPORATION, Tokyo (JP)

(21) Appl. No.: 19/489,594

(22) PCT Filed: Aug. 1, 2023
(86) PCT No.: PCT/JP2023/028146

§ 371 Date: Dec. 3, 2025

(51) Int. Cl. B25J 9/16; G06T 7/70

(52) U.S. Cl. CPC B25J 9/1664; B25J 9/1697; G06T 7/70

(57) ABSTRACT

A motor controller includes a frame vibration estimation unit that calculates a frame vibration estimate value, based on a motor thrust and a frame weight estimate value, a vibration error compensation signal calculation unit that calculates, based on the frame vibration estimate value, a vibration error compensation signal a motor drive control unit that generates a motor thrust command, based on a movable object position command, a motor position detection value, and the vibration error compensation signal, a relative position acquisition unit that acquires a movable object relative position detection value from an image captured by a camera that captures an image of a target position, a frame vibration calculation unit that calculates a frame vibration calculation value from the movable object relative position detection value, and a frame weight estimation unit that calculates the frame weight estimate value from the frame vibration calculation value and the motor thrust.

### FIELD

The present disclosure relates to a motor controller, a positioning apparatus, and a motor control method for positioning a movable object relative to a target position.

### BACKGROUND

Motor controllers for controlling thrust generated by a motor to position a movable object connected to the motor relative to a target position are known. For example, such motor controllers are used in the field of manufacturing electronic boards and semiconductors, and are installed in manufacturing apparatuses such as chip mounters and chip bonders for mounting electronic components, integrated circuit (IC) chips, and the like on boards. In this case, the movable object is a mounting head with a suction nozzle for holding and carrying an object to be mounted such as an electronic component or an IC chip. The mounting head moves to an area in which an electronic component or an IC chip is supplied, picks up the supplied electronic component or IC chip with the suction nozzle, then moves to a position above the target position on the board, and releases the electronic component or the IC chip from the suction nozzle, thereby mounting the electronic component or the IC chip on the board.

The mounting head is moved by a combination of a rotary motor and a linear motion mechanism or a linear motor mechanism, and is feedback-controlled based on a value detected by an encoder that detects the rotational position of the motor or the position of a linear motor mover, to position the movable object. That is, the feedback control is not performed by directly detecting whether the suction nozzle or the object to be mounted is actually positioned at the target position on the board.

In recent years, miniaturization of electronic components and IC chips has advanced, and higher positioning accuracy has been required. Further, to improve productivity, it is also required to shorten the time between the picking up and release of an electronic component or an IC chip, and it is necessary to move the mounting head at high speed, high acceleration, or high deceleration. When the mounting head is moved at high acceleration or high deceleration, an apparatus frame on which the mounting head and the board are installed is vibrated. This vibration may cause vibrational errors between the movable object and the target position on the board. When vibration occurs in the apparatus frame, an error in positioning the movable object may occur.

Patent Literature 1 discloses a technique to compensate an error in positioning a movable object by performing image processing on an image captured by a camera, calculating a target position in the captured image, and moving the movable object based on a current target position estimated by compensating for a delay associated with the image capturing and the image processing. Patent Literature 1 further discloses using a frame vibration model for an error due to frame vibration to estimate a current target position to compensate the error.

### CITATION LIST

### Patent Literature

Patent Literature 1: Japanese Patent Application Laid-open No. 2015-213139

### SUMMARY OF INVENTION

### Problem to be Solved by the Invention

However, the above conventional technique has a problem that parameters used in the frame vibration model may be set inappropriately, preventing a positioning error due to vibration of an apparatus frame from being sufficiently reduced. The frame vibration model used in the above conventional technique uses parameters such as the mass of a moving part. These parameters can be calculated from apparatus design data in an ideal case. However, actual apparatuses often do not have characteristics as designed. There is a high probability that even using the parameters calculated from the apparatus design data, the vibration of the apparatus frame cannot be accurately estimated.

The present disclosure has been made in view of the above. It is an object of the present disclosure to provide a motor controller capable of reducing a positioning error due to vibration of an apparatus frame.

### Means to Solve the Problem

In order to solve the above-described problem and achieve the object, the present disclosure is a motor controller to control, based on a motor thrust command, thrust generated by a motor mechanically connected to a movable object installed movably relative to an apparatus frame, to stop the movable object at a predetermined position relative to a target position, the motor controller comprises: a movable object position command generation unit to generate a movable object position command to stop the movable object at the predetermined position relative to the target position; a motor position acquisition unit to acquire a motor position detection value that is a time waveform of a position coordinate of the motor; a frame vibration estimation unit to calculate a frame vibration estimate value obtained by estimating vibration of the apparatus frame, based on the thrust generated by the motor and a frame weight estimate value obtained by estimating a weight of the apparatus frame; a vibration error compensation signal calculation unit to calculate, based on the frame vibration estimate value, a vibration error compensation signal to reduce an error due to the vibration of the apparatus frame included in a relative position of the movable object relative to the target position; and a motor drive control unit to generate the motor thrust command, based on the movable object position command, the motor position detection value, and the vibration error compensation signal. Additionally, the motor controller comprises a relative position acquisition unit to acquire a movable object relative position detection value that is a time waveform of a position coordinate of the movable object relative to the target position from an image captured by a camera to capture an image of the target position; a frame vibration calculation unit to calculate a frame vibration calculation value from the movable object relative position detection value; and a frame weight estimation unit to calculate the frame weight estimate value obtained by estimating the weight of the apparatus frame from the frame vibration calculation value and the thrust generated by the motor. The frame vibration estimation unit calculates the frame vibration estimate value, using the frame weight estimate value estimated by the frame weight estimation unit.

### Effects of the Invention

The present disclosure achieves the effect of allowing reduction of a positioning error due to vibration of the apparatus frame.

### BRIEF DESCRIPTION OF DRAWINGS

FIG. 1 is a diagram illustrating a configuration of a positioning apparatus according to a first embodiment.

FIG. 2 is a diagram illustrating an example of how an apparatus frame vibrates.

FIG. 3 is a flowchart for explaining an operation in which a motor controller according to the first embodiment controls a motor.

FIG. 4 is a flowchart for explaining an operation in which the motor controller according to the first embodiment updates parameters used to estimate frame vibration.

FIG. 5 is a diagram illustrating dedicated hardware for implementing the functions of the motor controller.

FIG. 6 is a diagram illustrating a configuration of a control circuit for implementing the functions of the motor controller.

FIG. 7 is a diagram illustrating a configuration of a positioning apparatus according to a second embodiment.

FIG. 8 is a flowchart for explaining an operation in which a motor controller according to the second embodiment updates parameters used to estimate frame vibration.

FIG. 9 is a diagram illustrating a configuration of a positioning apparatus according to a third embodiment.

FIG. 10 is a diagram illustrating a detailed configuration of a frame vibration estimation unit illustrated in FIG. 9.

FIG. 11 is a diagram illustrating a configuration of a positioning apparatus according to a fourth embodiment.

### DESCRIPTION OF EMBODIMENTS

Hereinafter, a motor controller, a positioning apparatus, and a motor control method according to embodiments of the present disclosure will be described in detail with reference to the drawings.

### First Embodiment

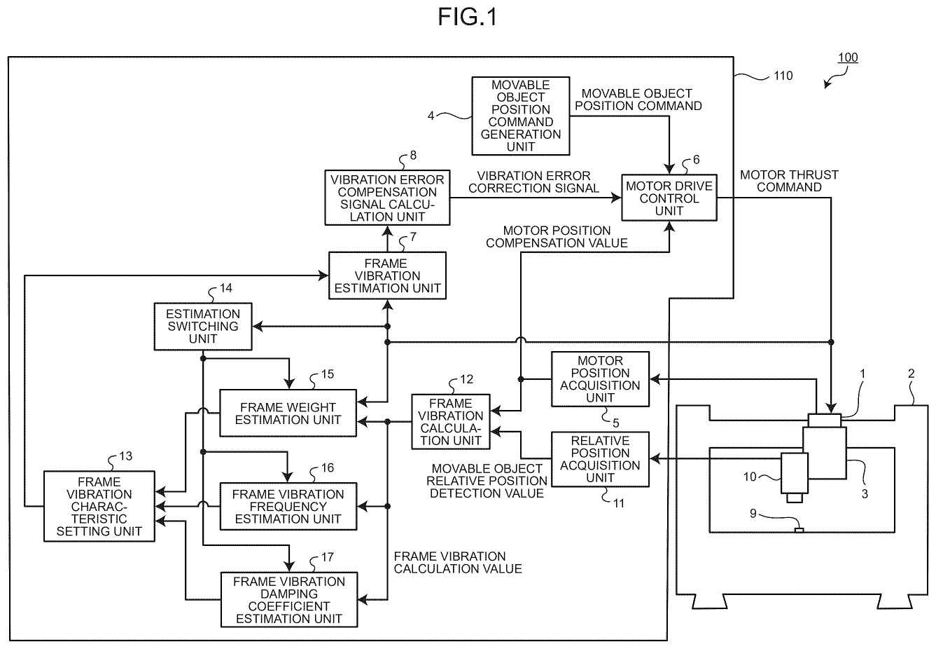

FIG. 1 is a diagram illustrating a configuration of a positioning apparatus 100 according to a first embodiment. The positioning apparatus 100 includes a motor 1 installed on an apparatus frame 2, the apparatus frame 2, and a movable object 3 mechanically connected to the motor 1. The movable object 3 is movable relative to the apparatus frame 2 with thrust generated by the motor 1. For example, the movable object 3 is attached to an upper portion of the apparatus frame 2, and is movable in a space above a work surface on the apparatus frame 2. A target position 9 is set on the work surface. The movable object 3 is controlled so that its relative position relative to the target position 9 becomes a predetermined position. The positioning apparatus 100 includes a camera 10 that captures images of the target position 9. The camera 10 is fixed to the movable object 3, and its position changes as the movable object 3 moves. In the first embodiment, it is assumed that captured images acquired by the camera 10 include the target position 9 even when the camera 10 moves.

The positioning apparatus 100 is installed, for example, in a manufacturing apparatus that manufactures electronic boards, semiconductors, or the like to be used in electronic equipment. In the case where the positioning apparatus 100 is installed in a manufacturing apparatus for electronic boards, semiconductors, or the like, the movable object 3 includes, for example, a means to perform a predetermined operation, and can perform the operation at a stopping position after moving to the target position 9. For example, the movable object 3 may be a mounting head with a means to hold an object, such as a suction nozzle. In the case where the movable object 3 is the mounting head, the movable object 3 can move above a board, holding an object such as an electronic component or an IC chip with the suction nozzle, stop at the target position 9 set on the board, and release the held object, thereby mounting the electronic component or the IC chip on the board.

The positioning apparatus 100 further includes a motor controller 110 that controls the motor 1. The motor controller 110 controls thrust generated by the motor 1, based on a motor thrust command. The motor controller 110 includes a movable object position command generation unit 4, a motor position acquisition unit 5, a motor drive control unit 6, a frame vibration estimation unit 7, a vibration error compensation signal calculation unit 8, a relative position acquisition unit 11, a frame vibration calculation unit 12, a frame vibration characteristic setting unit 13, an estimation switching unit 14, a frame weight estimation unit 15, a frame vibration frequency estimation unit 16, and a frame vibration damping coefficient estimation unit 17.

The movable object position command generation unit 4 generates a movable object position command to cause the movable object 3 to stop at a predetermined position relative to the target position 9. The movable object position command generation unit 4 outputs the generated movable object position command to the motor drive control unit 6. The movable object position command may be for the movable object 3 to stop right above the target position 9, or may be for the movable object 3 to stop at a position where the movable object 3 can perform a predetermined operation on the target position 9. For example, in the case where the movable object 3 is the mounting head, the movable object position command can be to cause the movable object 3 to stop at a predetermined position relative to the target position 9 to make the position of the suction nozzle of the movable object 3 coincide with the target position 9 so that the movable object 3 can mount an object such as an electronic component on the target position 9.

The motor position acquisition unit 5 acquires a motor position detection value that is the time waveform of a position coordinate of the motor 1. The motor position acquisition unit 5 outputs the acquired motor position detection value to each of the motor drive control unit 6 and the frame vibration calculation unit 12.

The motor drive control unit 6 generates the motor thrust command, based on the movable object position command output by the movable object position command generation unit 4, the motor position detection value output by the motor position acquisition unit 5, and a vibration error compensation signal output by the vibration error compensation signal calculation unit 8 described below. The motor drive control unit 6 can control thrust generated by the motor 1 by outputting the motor thrust command to the motor 1. When the motor 1 generates thrust according to the motor thrust command, the movable object 3 moves.

The frame vibration estimation unit 7 calculates a frame vibration estimate waveform obtained by estimating frame vibration occurring in the apparatus frame 2, based on the motor thrust command indicating thrust to be generated by the motor 1 and parameters set by the frame vibration characteristic setting unit 13. The frame vibration estimation unit 7 outputs the calculated frame vibration estimate waveform to the vibration error compensation signal calculation unit 8 as a frame vibration estimate value.

The vibration error compensation signal calculation unit 8 calculates the vibration error compensation signal to reduce an error generated in the position of the movable object 3 due to vibration of the apparatus frame 2, from the frame vibration estimate value output by the frame vibration estimation unit 7. The vibration error compensation signal calculation unit 8 outputs the calculated vibration error compensation signal to the motor drive control unit 6.

As described above, the motor controller 110 controls the operation of positioning of the movable object 3 relative to the target position 9, based on the movable object position command generated by the movable object position command generation unit 4. At this time, if disturbance such as friction occurs, or there is an error between the thrust of the motor 1 to move the movable object 3 and the motor thrust command output from the motor drive control unit 6, a positioning error occurs in the movable object 3 relative to the target position 9. Therefore, the motor drive control unit 6 successively changes the motor thrust command, based on the motor position detection value that is the detected value of the position of the motor 1 acquired by the motor position acquisition unit 5, to cause the motor 1 to operate so that the movable object 3 is positioned relative to the target position 9. However, if the motor 1 and the movable object 3 repeat acceleration and deceleration, the reaction force is transmitted to the apparatus frame 2, and the apparatus frame 2 may vibrate.

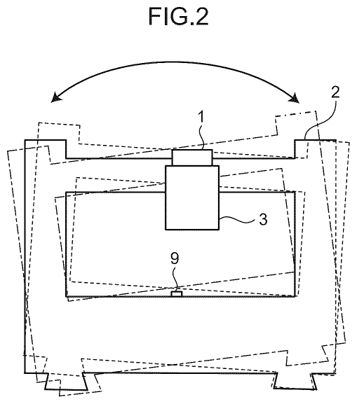

FIG. 2 is a diagram illustrating an example of how the apparatus frame 2 vibrates. FIG. 2 illustrates a state in which the apparatus frame 2 is undergoing rocking vibration, rotating around a lower portion of the apparatus frame 2 due to a reaction force associated with acceleration and deceleration of the motor 1 and the movable object 3. When the apparatus frame 2 vibrates, the motor 1, the movable object 3, and the target position 9 installed on the apparatus frame 2 also vibrate with the vibration of the apparatus frame 2.

The relationship between the vibration waveform of the movable object 3 and the vibration waveform of the target position 9 when the apparatus frame 2 is vibrating as illustrated in FIG. 2 is expressed as R×Ah(t)×sin(ωt+φ)=Ao(t)×sin(θt+φ), using a coefficient R (0<R≤1), where Ah(t)×sin(ωt+φ) is the vibration waveform of the movable object 3, and Ao(t)×sin(ωt+φ) is the vibration waveform of the target position 9. That is, due to the vibration of the apparatus frame 2, a vibration waveform of (1−R)Ah(t)×sin(ωt+φ) is generated as the relative error between the movable object 3 and the target position 9.

Since the vibration of the apparatus frame 2 causing the relative error is due to the acceleration and deceleration of the motor 1 and the movable object 3, the above-described frame vibration estimation unit 7 can calculate the vibration waveform of the apparatus frame 2 from the motor thrust command. Specifically, the frame vibration estimation unit 7 can calculate the vibration waveform of the apparatus frame 2, using the equation of motion represented by formula group (1) below, where m is a frame weight estimate value that is an estimate value of the weight of the apparatus frame 2, w is a frame vibration frequency estimate value that is an estimate value of the vibration frequency of the apparatus frame 2, and 4 is a frame vibration damping coefficient estimate value that is an estimate value of the vibration damping coefficient of the apparatus frame 2.

$$Formula 1 :$$

$$\begin{matrix}m \ddot{x} ( t ) + c \dot{x} ( t ) + kx ( t ) = F ( t ) \\ ω = \sqrt{\frac{k}{m}} , ζ = \frac{c}{2 \sqrt{mk}} \\ \ddot{x} ( t ) + \frac{c}{m} \dot{x} ( t ) + \frac{k}{m} x ( t ) = \frac{F ( t )}{m} \\ \ddot{x} ( t ) + 2 ζω \dot{x} ( t ) + {ω}^{2} x ( t ) = \frac{F ( t )}{m}\end{matrix} \} \qquad ( 1 )$$

The frame vibration estimation unit 7 outputs the waveform (1−R)Ah(t)×sin(ωt+φ) obtained by multiplying the estimated vibration waveform of the apparatus frame 2 by (1−R) to the vibration error compensation signal calculation unit 8 as the frame vibration estimate value.

The vibration error compensation signal calculation unit 8 calculates the vibration error compensation signal so as to move the motor 1 and the movable object 3 with the waveform (−1)×(1−R)Ah(t)×sin(ωt+φ) obtained by inverting the waveform output by the frame vibration estimation unit 7. Consequently, the vibration (1−R)Ah(t)×sin(ωt+φ) occurring as the relative error between the movable object 3 and the target position 9 due to the vibration of the apparatus frame 2 can be canceled out to reduce the error.

Here, if the values of the frame weight estimate value m, the frame vibration frequency estimate value ω, and the frame vibration damping coefficient estimate value ζ used by the frame vibration estimation unit 7 are different from the actual characteristics of the apparatus frame 2, the estimation accuracy of the frame vibration estimate value is reduced, and it is difficult to reduce the relative error generated between the movable object 3 and the target position 9. Therefore, the motor controller 110 has a function to update the values of the frame weight estimate value m, the frame vibration frequency estimate value ω, and the frame vibration damping coefficient estimate value ζ used by the frame vibration estimation unit 7, using a movable object relative position detection value of the movable object 3 actually detected.

The relative position acquisition unit 11 acquires an image captured by the camera 10, detects, from the acquired captured image, the position of the target position 9 in the captured image, and acquires the movable object relative position detection value as the position of the movable object 3 relative to the target position 9. The relative position acquisition unit 11 outputs the acquired movable object relative position detection value to the frame vibration calculation unit 12.

The frame vibration calculation unit 12 calculates the vibration waveform of vibration occurring in the apparatus frame 2, based on the motor position detection value output by the motor position acquisition unit 5 and the movable object relative position detection value output by the relative position acquisition unit 11. The frame vibration calculation unit 12 outputs the calculated vibration waveform as a frame vibration calculation value to each of the frame weight estimation unit 15, the frame vibration frequency estimation unit 16, and the frame vibration damping coefficient estimation unit 17. Since the motor position detection value indicates the position of the motor 1 and the movable object 3 relative to the upper portion of the apparatus frame 2, the frame vibration calculation unit 12 can obtain a remaining travel amount Er of the movable object 3 relative to the target position 9 from the motor position detection value. Since the movable object relative position detection value is calculated from the image captured by the camera 10 installed on the movable object 3, that value is the sum of the remaining travel amount Er and the vibration waveform (1−R)Ah×sin(ωt+φ) generated as the relative error between the movable object 3 and the target position 9. Thus, the frame vibration calculation unit 12 can calculate the vibration waveform (1−R)Ah(t)×sin(ωt+φ), which is the relative error generated between the movable object 3 and the target position 9 due to the vibration of the apparatus frame 2, from the movable object relative position detection value and the motor position detection value, and output the calculated vibration waveform as the frame vibration calculation value. Note that the frame vibration calculation value has a large delay due to image processing necessary to calculate the movable object relative position detection value, and cannot be used to generate the vibration error compensation signal.

The frame vibration characteristic setting unit 13 stores each of the frame weight estimate value m, the frame vibration frequency estimate value ω, and the frame vibration damping coefficient estimate value ζ estimated by the frame weight estimation unit 15, the frame vibration frequency estimation unit 16, and the frame vibration damping coefficient estimation unit 17 to be described below, and sets the stored values as the parameters to be used by the frame vibration estimation unit 7.

The estimation switching unit 14 determines a period during which each of the frame weight estimation unit 15, the frame vibration frequency estimation unit 16, and the frame vibration damping coefficient estimation unit 17 performs an estimation operation. Of the frame weight estimate value m, the frame vibration frequency estimate value ω, and the frame vibration damping coefficient estimate value ζ, the frame vibration frequency estimate value ω and the frame vibration damping coefficient estimate value ζ can be estimated from the vibration waveform of free vibration in a state where the apparatus frame 2 is not acted upon by an external force, that is, in a state where the motor 1 is not generating thrust for acceleration and deceleration. The frame weight estimate value m can be estimated in a state where the apparatus frame 2 is acted upon by an external force, that is, in a state where the motor 1 is generating thrust for acceleration or deceleration. Whether or not the apparatus frame 2 is being acted upon by an external force can be determined from the motor thrust command input to the motor 1. Thus, the estimation switching unit 14 determines whether or not the motor 1 is generating thrust for acceleration or deceleration, based on the motor thrust command, causes the frame weight estimation unit 15 to perform the estimation operation during a period in which the motor 1 is accelerating or decelerating for travel, and causes the frame vibration frequency estimation unit 16 and the frame vibration damping coefficient estimation unit 17 to perform the estimation operations during a period in which the motor 1 is neither accelerating nor decelerating.

The frame weight estimation unit 15 performs the operation of estimating the frame weight estimate value m from data acquired in the period determined by the estimation switching unit 14 as the period in which to perform the estimation operation. The frame weight estimation unit 15 estimates the frame weight estimate value m, based on the frame vibration calculation value output by the frame vibration calculation unit 12 and the motor thrust command output by the motor drive control unit 6. Specifically, the frame weight estimation unit 15 calculates the frame weight estimate value m so as to minimize the difference between the vibration waveform calculated using formula group (1) with the waveform obtained by inverting the sign of the motor thrust command as the reaction force acting on the apparatus frame 2, and the frame vibration calculation value. As a method for this calculation, a least squares method can be used.

The frame vibration frequency estimation unit 16 performs the operation of estimating the frame vibration frequency estimate value ω from data acquired in the period determined by the estimation switching unit 14 as the period in which to perform the estimation operation. The frame vibration frequency estimation unit 16 estimates the frame vibration frequency estimate value ω, based on the frame vibration calculation value output by the frame vibration calculation unit 12. Specifically, the frame vibration frequency estimation unit 16 may measure the time interval between zero crossings of the waveform of the frame vibration calculation value, and calculate the frame vibration frequency estimate value ω from the measured time interval, or may calculate the frame vibration frequency estimate value ω using a fast Fourier transform (FFT).

The frame vibration damping coefficient estimation unit 17 performs the operation of estimating the frame vibration damping coefficient estimate value ζ from data acquired in the period determined by the estimation switching unit 14 as the period in which to perform the estimation operation. The frame vibration damping coefficient estimation unit 17 estimates the frame vibration damping coefficient estimate value ζ, based on the frame vibration calculation value output by the frame vibration calculation unit 12. Specifically, the frame vibration damping coefficient estimation unit 17 can calculate the frame vibration damping coefficient estimate value ζ from changes in the vibration amplitude of the frame vibration calculation value over time.

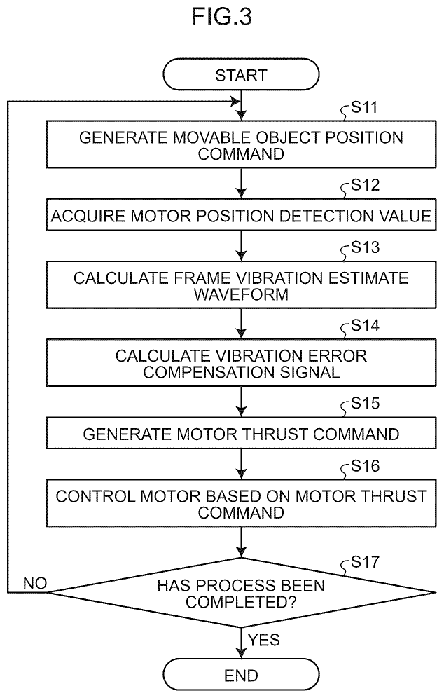

Here, an operation of the motor controller 110 will be described. FIG. 3 is a flowchart for explaining an operation in which the motor controller 110 according to the first embodiment controls the motor 1. The movable object position command generation unit 4 of the motor controller 110 generates the movable object position command to stop the movable object 3 at a predetermined position relative to the target position 9 (step S11), and outputs the generated movable object position command to the motor drive control unit 6.

The motor position acquisition unit 5 acquires the motor position detection value (step S12), and outputs the acquired motor position detection value to each of the frame vibration calculation unit 12 and the motor drive control unit 6. The frame vibration estimation unit 7 calculates the frame vibration estimate waveform, using the motor thrust command output by the motor drive control unit 6 and the parameters set by the frame vibration characteristic setting unit 13, specifically, the frame weight estimate value m, the frame vibration frequency estimate value ω, and the frame vibration damping coefficient estimate value ζ (step S13), and outputs the calculated frame vibration estimate waveform to the vibration error compensation signal calculation unit 8 as the frame vibration estimate value.

The vibration error compensation signal calculation unit 8 calculates the vibration error compensation signal, based on the frame vibration estimate value output by the frame vibration estimation unit 7 (step S14), and outputs the calculated vibration error compensation signal to the motor drive control unit 6.

The motor drive control unit 6 generates the motor thrust command to control the motor 1, based on the movable object position command, the motor position detection value, and the vibration error compensation signal (step S15).

The motor drive control unit 6 outputs the generated motor thrust command to the motor 1 to control the motor 1 based on the motor thrust command (step S16). At this time, the motor drive control unit 6 also outputs the generated motor thrust command to each of the frame vibration estimation unit 7, the estimation switching unit 14, and the frame weight estimation unit 15.

The motor controller 110 determines whether or not the process has been completed (step S17). When the motor controller 110 determines that the process has not been completed (step S17: No), the motor controller 110 repeats the process from step S11. When the motor controller 110 determines that the process has been completed (step S17: Yes), the motor controller 110 completes the control process of the motor 1.

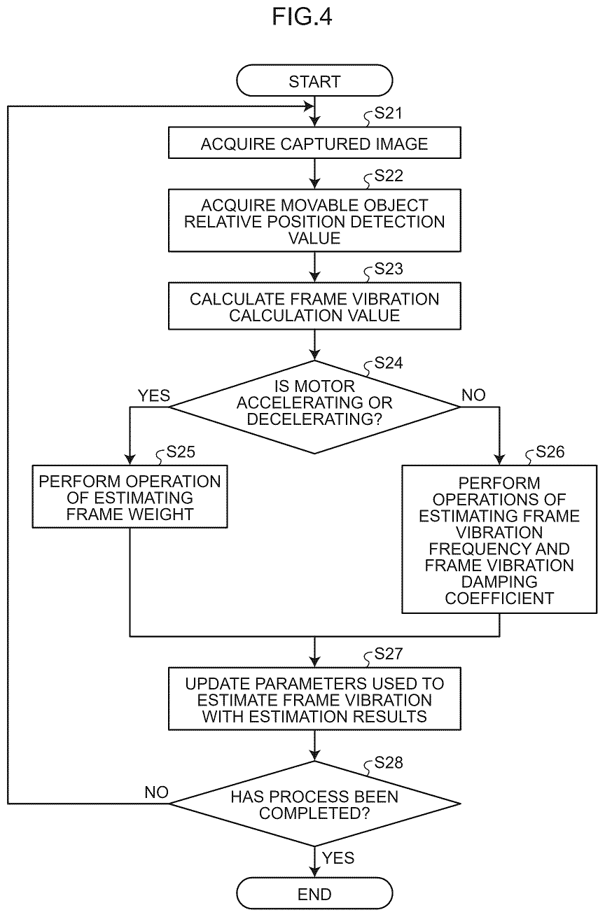

In parallel with the control operation of the motor 1 illustrated in FIG. 3, the motor controller 110 performs an operation to update the parameters used to estimate frame vibration. FIG. 4 is a flowchart for explaining an operation in which the motor controller 110 according to the first embodiment updates the parameters used to estimate frame vibration.

The motor controller 110 acquires an image captured by the camera 10 (step S21). The relative position acquisition unit 11 acquires the movable object relative position detection value, which is the time waveform of a position coordinate of the movable object 3 relative to the target position 9, from the image captured by the camera 10 (step S22), and outputs the acquired movable object relative position detection value to the frame vibration calculation unit 12.

The frame vibration calculation unit 12 calculates the frame vibration calculation value from the movable object relative position detection value output by the relative position acquisition unit 11 (step S23), and outputs the calculated frame vibration calculation value to each of the frame weight estimation unit 15, the frame vibration frequency estimation unit 16, and the frame vibration damping coefficient estimation unit 17.

The estimation switching unit 14 determines whether or not the motor 1 is accelerating or decelerating, based on the motor thrust command output by the motor drive control unit 6 (step S24). When the motor 1 is accelerating or decelerating (step S24: Yes), the estimation switching unit 14 causes the frame weight estimation unit 15 to perform the operation of estimating the frame weight (step S25), and the frame weight estimation unit 15 outputs the frame weight estimate value m as the estimation result to the frame vibration characteristic setting unit 13. When the motor 1 is neither accelerating nor decelerating (step S24: No), the estimation switching unit 14 causes the frame vibration frequency estimation unit 16 and the frame vibration damping coefficient estimation unit 17 to perform the operations of estimating the frame vibration frequency and the frame vibration damping coefficient (step S26), the frame vibration frequency estimation unit 16 outputs the frame vibration frequency estimate value ω as the estimation result to the frame vibration characteristic setting unit 13, and the frame vibration damping coefficient estimation unit 17 outputs the frame vibration damping coefficient estimate value ζ as the estimation result to the frame vibration characteristic setting unit 13.

The frame vibration characteristic setting unit 13 updates the parameters used by the frame vibration estimation unit 7 to estimate frame vibration, using the estimation results (step S27). The motor controller 110 determines whether or not the process has been completed (step S28). When the motor controller 110 determines that the process has not been completed (step S28: No), the motor controller 110 repeats the process from step S21. When the motor controller 110 determines that the process has been completed (step S28: Yes), the motor controller 110 completes the parameter update process.

Here, a hardware configuration of the motor controller 110 will be described. The function of each unit of the motor controller 110 is implemented by a processing circuit. These processing circuits may be implemented by dedicated hardware, or may be a control circuit using a central processing unit (CPU).

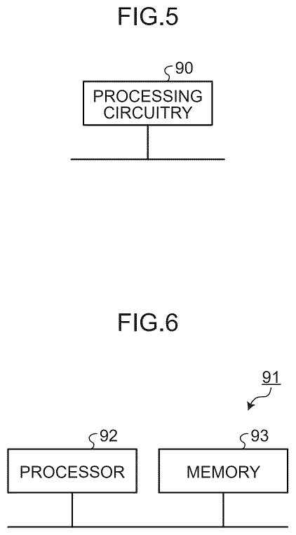

When the above processing circuits are implemented by dedicated hardware, these are implemented by processing circuitry 90 illustrated in FIG. 5. FIG. 5 is a diagram illustrating dedicated hardware for implementing the functions of the motor controller 110. The processing circuitry 90 is a single circuit, a combined circuit, a programmed processor, a parallel-programmed processor, an application-specific integrated circuit (ASIC), a field-programmable gate array (FPGA), or a combination thereof.

When the above processing circuits are implemented by a control circuit using a CPU, the control circuit is, for example, a control circuit 91 of a configuration illustrated in FIG. 6. FIG. 6 is a diagram illustrating a configuration of the control circuit 91 for implementing the functions of the motor controller 110. As illustrated in FIG. 6, the control circuit 91 includes a processor 92 and memory 93. The processor 92 is a CPU and is also called a processing device, an arithmetic device, a microprocessor, a microcomputer, a digital signal processor (DSP), or the like. The memory 93 is, for example, nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disk (DVD), or the like.

When implemented by the control circuit 91, the above processing circuits are implemented by the processor 92 reading and executing a program corresponding to the processing of each component stored in the memory 93. The memory 93 is also used as a temporary memory in each piece of processing executed by the processor 92. Note that the programs executed by the processor 92 may be provided in a state of being stored in a storage medium, or may be provided via a communication channel such as the Internet.

As described above, the first embodiment can provide the motor controller 110 that controls, based on the motor thrust command, thrust generated by the motor 1, to thereby stop the movable object 3 at a predetermined position relative to the target position 9, the motor being mechanically connected to the movable object 3, the movable object 3 being installed movably relative to the apparatus frame 2. The motor controller 110 includes the movable object position command generation unit 4 that generates the movable object position command to stop the movable object 3 at the predetermined position relative to the target position 9, the motor position acquisition unit 5 that acquires the motor position detection value, which is the time waveform of the position coordinate of the motor 1, the frame vibration estimation unit 7 that calculates the frame vibration estimate value obtained by estimating vibration of the apparatus frame 2, based on the thrust generated by the motor 1 and the frame weight estimate value m that is an estimated weight of the apparatus frame 2, the vibration error compensation signal calculation unit 8 that calculates the vibration error compensation signal to reduce an error due to the vibration of the apparatus frame 2 included in the relative position of the movable object 3 relative to the target position 9, based on the frame vibration estimate value, and the motor drive control unit 6 that generates the motor thrust command, based on the movable object position command, the motor position detection value, and the vibration error compensation signal. The motor controller 110 further includes the relative position acquisition unit 11 that acquires the movable object relative position detection value, which is the time waveform of the position coordinate of the movable object 3 relative to the target position 9, from an image captured by the camera 10 that captures an image of the target position 9, the frame vibration calculation unit 12 that calculates the frame vibration calculation value from the movable object relative position detection value, and the frame weight estimation unit 15 that calculates the frame weight estimate value m obtained by estimating the weight of the apparatus frame 2 from the frame vibration calculation value and the thrust generated by the motor 1. The frame vibration estimation unit 7 can calculate the frame vibration estimate value, using the frame weight estimate value m estimated by the frame weight estimation unit 15. Thus, the motor controller 110 calculates the frame weight estimate value from the frame vibration detection value detected from an image captured during actual operation and the thrust generated by the motor 1, and thus can determine the frame weight estimate value m with high accuracy. Further, the motor controller 110 estimates vibration generated in the apparatus frame 2, using the frame weight estimate value m with high accuracy, and reduces an error due to the estimated vibration, and thus can reduce a positioning error with high accuracy.

The motor controller 110 can further include the estimation switching unit 14 that determines a period during which the frame weight estimation unit 15 performs the estimation operation, based on the thrust generated by the motor 1. Specifically, the estimation switching unit 14 causes the frame weight estimation unit 15 to perform the estimation operation during a period in which the motor 1 is accelerating or decelerating for travel. This makes it possible to obtain the frame weight estimate value m with higher accuracy.

The motor controller 110 further includes the frame vibration frequency estimation unit 16 that calculates the frame vibration frequency estimate value ω obtained by estimating the frame vibration frequency from the frame vibration calculation value, and the frame vibration damping coefficient estimation unit 17 that calculates the frame vibration damping coefficient estimate value ζ obtained by estimating the frame vibration damping coefficient from the frame vibration calculation value. The frame vibration estimation unit 7 calculates the frame vibration estimate value, based on the frame vibration frequency estimate value ω and the frame vibration damping coefficient estimate value ζ. The estimation switching unit 14 can cause the frame vibration frequency estimation unit 16 and the frame vibration damping coefficient estimation unit 17 to perform the estimation operations during a period in which the motor 1 is neither accelerating nor decelerating. Consequently, also for the frame vibration frequency and the frame vibration damping coefficient, highly accurate values can be obtained, and a positioning error can be reduced with higher accuracy.

### Second Embodiment

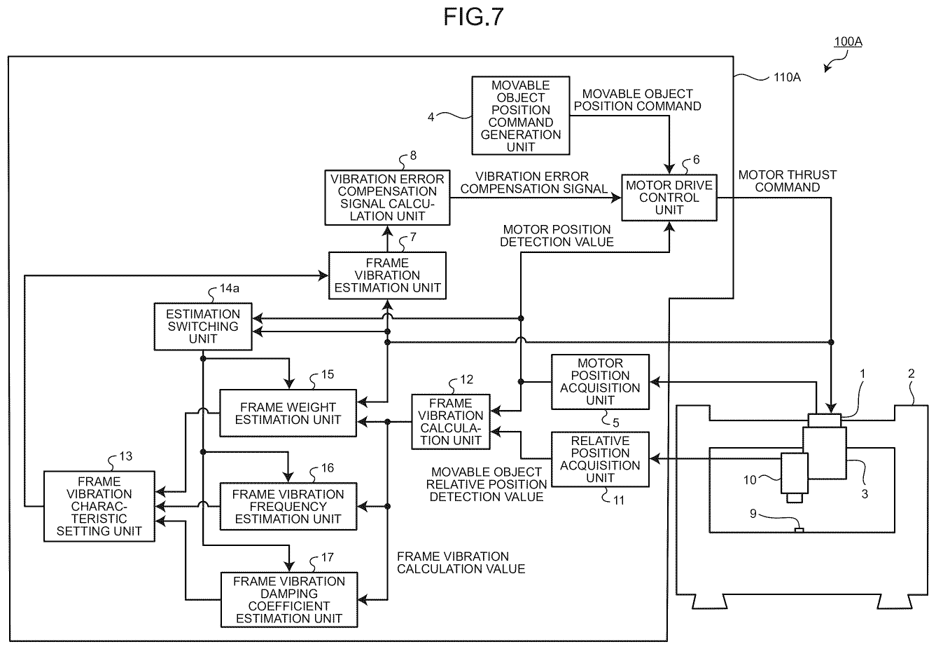

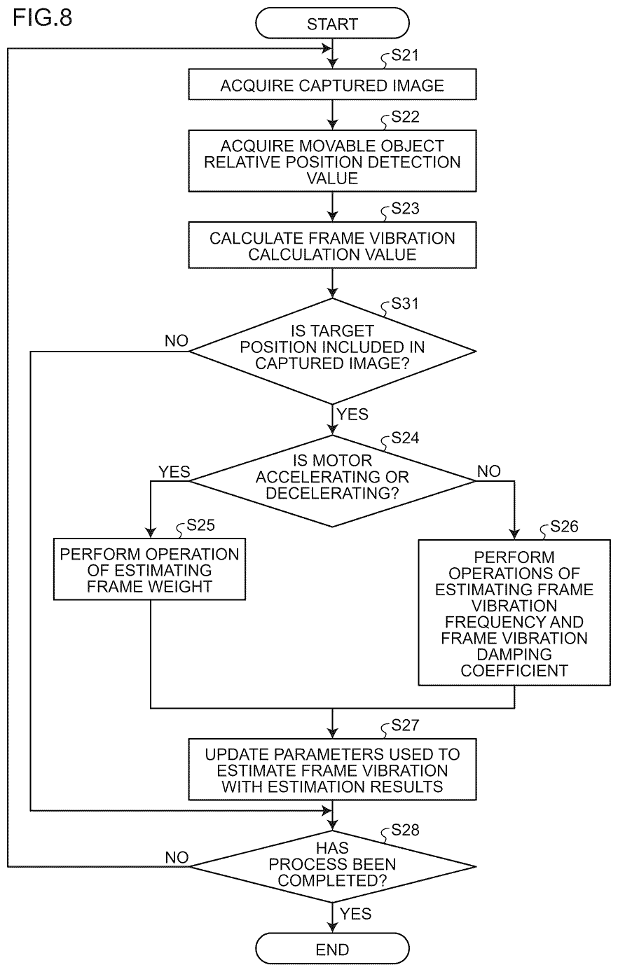

FIG. 7 is a diagram illustrating a configuration of a positioning apparatus 100A according to a second embodiment. The positioning apparatus 100A includes a motor controller 110A instead of the motor controller 110 of the positioning apparatus 100. The configuration of the motor controller 110A is the same as that of the motor controller 110 according to the first embodiment except that an estimation switching unit 14a is included instead of the estimation switching unit 14. The following mainly describes differences from the first embodiment and omits descriptions of the same portions as those of the first embodiment.

The estimation switching unit 14a receives input of the motor position detection value output by the motor position acquisition unit 5 in addition to the motor thrust command output by the motor drive control unit 6. The estimation switching unit 14a determines a period during which each of the frame weight estimation unit 15, the frame vibration frequency estimation unit 16, and the frame vibration damping coefficient estimation unit 17 performs the estimation operation, based on the motor thrust command and the motor position detection value.

The frame vibration calculation value used by the frame weight estimation unit 15, the frame vibration frequency estimation unit 16, and the frame vibration damping coefficient estimation unit 17 in the estimation operations is calculated from the movable object relative position detection value. The movable object relative position detection value is a value obtained by detecting the position of the target position 9 in an image captured by the camera 10 and acquiring the position of the movable object 3 relative to the target position 9. In the first embodiment, it is assumed that the camera 10 moves in a range in which the target position 9 is included in the image-capturing area, and images captured by the camera 10 include the target position 9 even when the camera 10 moves. However, in order to obtain the position detection value with high resolution, the camera 10 may not be able to capture an image of a wide area due to constraints of the picture elements and image transfer speed. Therefore, in the second embodiment, it is assumed that some images captured by the camera 10 include the target position 9 and other images do not include the target position 9. When a captured image does not include the target position 9, the movable object relative position detection value cannot be obtained. Therefore, the estimation switching unit 14a causes each of the frame weight estimation unit 15, the frame vibration frequency estimation unit 16, and the frame vibration damping coefficient estimation unit 17 to perform the estimation operation during a period in which the target position 9 is included in a captured image. Specifically, the estimation switching unit 14a determines whether or not the target position 9 is included in an image captured by the camera 10, based on the motor position detection value, and determines periods during which the estimation operations are performed so as to cause each of the frame weight estimation unit 15, the frame vibration frequency estimation unit 16, and the frame vibration damping coefficient estimation unit 17 to perform the estimation operation during a period in which the target position 9 is included in a captured image.

FIG. 8 is a flowchart for explaining an operation in which the motor controller 110A according to the second embodiment updates the parameters used to estimate frame vibration. Steps S21 to 323 are the same as those in the first embodiment. In the second embodiment, before step S24, the estimation switching unit 14a determines whether or not the target position 9 is included in an image captured by the camera 10 (step S31). When the target position 9 is included in the captured image (step S31: Yes), the processing in steps S24 to S27 as in the first embodiment is performed. When the target position 9 is not included in the captured image (step S31: No), the processing in steps S24 to S27 is omitted, and the process proceeds to the processing in step S28.

Thus, the estimation switching unit 14a of the motor controller 110A sets periods during which to perform the estimation operations so as to cause the frame weight estimation unit 15 to perform the estimation operation when the target position 9 is included in the captured image and the motor 1 is accelerating or decelerating, and to cause the frame vibration frequency estimation unit 16 and the frame vibration damping coefficient estimation unit 17 to perform the estimation operations when the target position 9 is included in the captured image and the motor 1 is neither accelerating nor decelerating. When the target position 9 is not included in the captured image, the estimation switching unit 14a does not cause any estimation operation to be performed.

As described above, the second embodiment can provide the motor controller 110A. In the motor controller 110A, the estimation switching unit 14a determines whether or not the target position 9 is included in an image captured by the camera 10, and causes the frame weight estimation unit 15 to perform the estimation operation during a period in which the target position 9 is included in the captured image. The estimation switching unit 14a determines whether or not the target position 9 is included in an image captured by the camera 10, and may cause the frame vibration frequency estimation unit 16 and the frame vibration damping coefficient estimation unit 17 to perform the estimation operations during a period in which the target position 9 is included in the captured image. Consequently, even in the case where the motor 1 and the movable object 3 move in a wide area in which the target position 9 is not included in some images captured by the camera 10, it is possible to obtain the frame weight estimate value m, the frame vibration frequency estimate value ω, and the frame vibration damping coefficient estimate value ζ with high accuracy.

In the above embodiment, the estimation switching unit 14a uses the motor thrust command and the motor position detection value to determine periods during which to perform the respective operations of estimating the frame weight estimate value m, the frame vibration frequency estimate value ω, and the frame vibration damping coefficient estimate value ζ. However, another signal may be used as long as the signal allows the determination of the state of acceleration and deceleration of the motor 1 and a period during which the target position 9 is included in an image captured by the camera 10. For example, whether or not the target position 9 is included in an image captured by the camera 10 may be determined, using the movable object position command generated by the movable object position command generation unit 4. Alternatively, the state of acceleration and deceleration of the motor 1 and whether or not the target position 9 is included in an image captured by the camera 10 may be determined, using only the movable object position command or only the motor position detection value.

### Third Embodiment

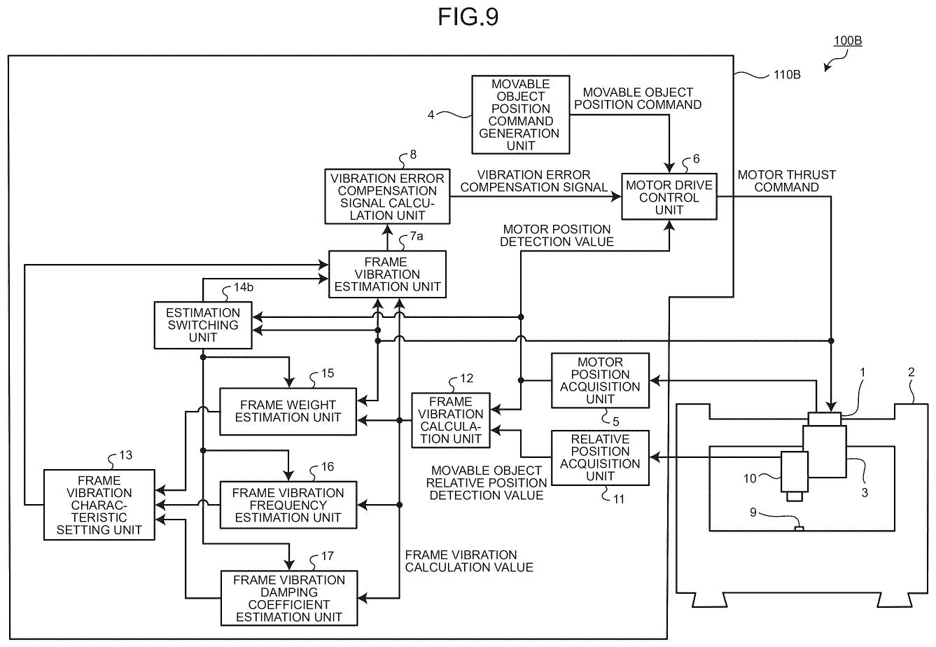

FIG. 9 is a diagram illustrating a configuration of a positioning apparatus 100B according to a third embodiment. The positioning apparatus 100B includes a motor controller 110B instead of the motor controller 110A of the positioning apparatus 100A. The configuration of the motor controller 110B is the same as that of the motor controller 110A according to the second embodiment except that a frame vibration estimation unit 7a is included instead of the frame vibration estimation unit 7 of the motor controller 110A, and an estimation switching unit 14b is included instead of the estimation switching unit 14a. The following mainly describes differences from the second embodiment and omits descriptions of the same portions as those of the second embodiment.

The frame vibration estimation unit 7a receives, in addition to input of the motor thrust command output by the motor drive control unit 6 and the parameters output by the frame vibration characteristic setting unit 13, input of the frame vibration calculation value output by the frame vibration calculation unit 12 and information indicating a period during which to change a calculation method output by the estimation switching unit 14b. The frame vibration estimation unit 7a has a function to perform a first method of calculating the frame vibration estimate value based on the motor thrust command in the same way as the frame vibration estimation unit 7, and a second method of calculating the frame vibration estimate value, using the frame vibration calculation value in addition to the motor thrust command. The frame vibration estimation unit 7a switches a method used to calculate the frame vibration estimate value between the first method and the second method, according to an instruction provided by the estimation switching unit 14b. It is considered that with the second method, the frame vibration estimate value can be determined with higher accuracy than with the first method. However, since the calculation of the frame vibration calculation value takes time due to image processing etc., the frame vibration calculation value is greatly delayed, and it is necessary to compensate for the effect of the delay.

The estimation switching unit 14b determines periods during which the frame weight estimation unit 15, the frame vibration frequency estimation unit 16, and the frame vibration damping coefficient estimation unit 17 perform the estimation operations, using the same method as that in the second embodiment, and determines a period during which the frame vibration estimation unit 7a changes the method of calculating the frame vibration estimate value. Specifically, the estimation switching unit 14b determines a period during which the frame vibration estimation unit 7a changes the method of calculating the frame vibration estimate value so that the frame vibration estimation unit 7a calculates the frame vibration estimate value with the second method during a period in which the target position 9 is included in an image captured by the camera 10, and the frame vibration estimation unit 7a calculates the frame vibration estimate value with the first method during a period in which the target position 9 is not included in a captured image.

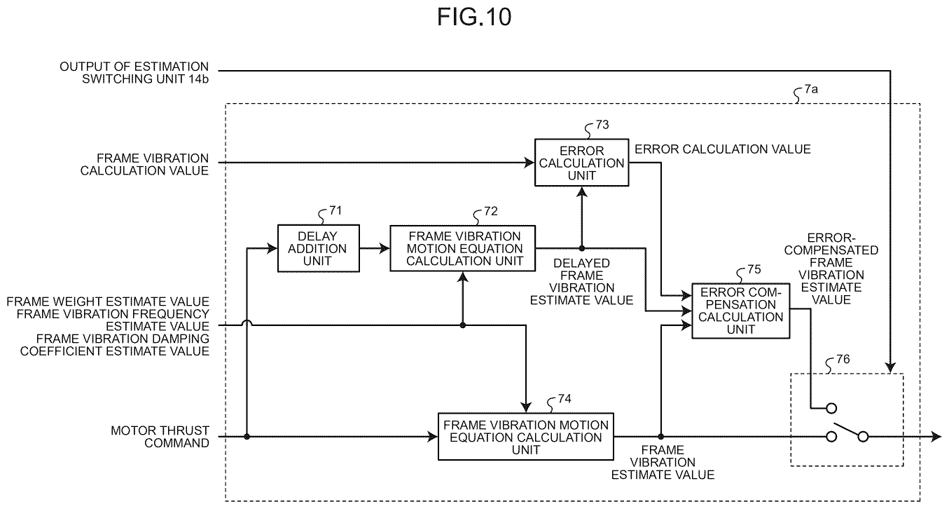

FIG. 10 is a diagram illustrating a detailed configuration of the frame vibration estimation unit 7a illustrated in FIG. 9. The frame vibration estimation unit 7a includes a delay addition unit 71, a frame vibration motion equation calculation unit 72, an error calculation unit 73, a frame vibration motion equation calculation unit 74, an error compensation calculation unit 75, and an output switching unit 76.

The delay addition unit 71 adds the same delay time as that of the delay included in the frame vibration calculation value to the motor thrust command, and outputs the motor thrust command with the added delay to the frame vibration motion equation calculation unit 72.

The frame vibration motion equation calculation unit 72 calculates a delayed frame vibration estimate value from the motor thrust command with the added delay, using parameters such as the frame weight estimate value m, the frame vibration frequency estimate value ω, and the frame vibration damping coefficient estimate value ζ. The frame vibration motion equation calculation unit 72 outputs the calculated delayed frame vibration estimate value to each of the error calculation unit 73 and the error compensation calculation unit 75.

The error calculation unit 73 calculates, as an error calculation value, an error obtained by comparing the frame vibration calculation value with the delayed frame vibration estimate value. The error calculation unit 73 outputs the calculated error calculation value to the error compensation calculation unit 75.

The frame vibration motion equation calculation unit 74 calculates the frame vibration estimate value from the motor thrust command with no added delay, using the parameters such as the frame weight estimate value m, the frame vibration frequency estimate value ω, and the frame vibration damping coefficient estimate value ζ. The frame vibration motion equation calculation unit 74 outputs the calculated frame vibration estimate value to each of the error compensation calculation unit 75 and the output switching unit 76.

The error compensation calculation unit 75 calculates an error-compensated frame vibration estimate value, using the error calculation value, the delayed frame vibration estimate value, and the frame vibration estimate value, and outputs the calculated error-compensated frame vibration estimate value to the output switching unit 76. Since the delayed frame vibration estimate value is delayed by the same amount as the frame vibration calculation value, the error calculation value calculated by the error calculation unit 73 includes the effects of estimation errors in the parameters such as the frame weight estimate value m, the frame vibration frequency estimate value ω, and the frame vibration damping coefficient estimate value ζ. The error compensation calculation unit 75 adds, to the frame vibration estimate value, a value calculated with the error calculation value assumed to have changed when the delay time has elapsed, based on the amount of change of the frame vibration estimate value with respect to the delayed frame vibration estimate value, that is, a change when the delay time has elapsed, and outputs the result as the error-compensated frame vibration estimate value. This allows the compensation of an error in the frame vibration estimate value that appears due to errors between the actual characteristics of the apparatus frame 2 and the parameters such as the frame weight estimate value m, the frame vibration frequency estimate value ω, and the frame vibration damping coefficient estimate value ζ.

The output switching unit 76 switches the output of the frame vibration estimation unit 7a between the frame vibration estimate value and the error-compensated frame vibration estimate value. Specifically, the output switching unit 76 switches the output of the frame vibration estimation unit 7a, according to an instruction provided by the estimation switching unit 14b.

As described above, according to the motor controller 110B of the third embodiment, the frame vibration estimation unit 7a can calculate the frame vibration estimate value, based on the thrust generated by the motor 1 and the frame vibration calculation value. The motor controller 110B can further include the estimation switching unit 14b that determines whether or not the target position 9 is included in an image captured by the camera 10, and causes the frame vibration estimation unit 7a to calculate the frame vibration estimate value, based on the thrust generated by the motor 1 and the frame vibration calculation value during a period in which the target position 9 is included in the captured image. Consequently, the frame vibration estimation unit 7a can calculate the frame vibration estimate value using an appropriate signal, and can obtain the frame vibration estimate value with higher accuracy, using the frame vibration calculation value. The motor controller 110B calculates the vibration error compensation signal, using the frame vibration estimate value with high accuracy, and thus can perform control to reduce a relative error generated between the movable object 3 and the target position 9 due to vibration of the apparatus frame 2 with higher accuracy.

### Fourth Embodiment

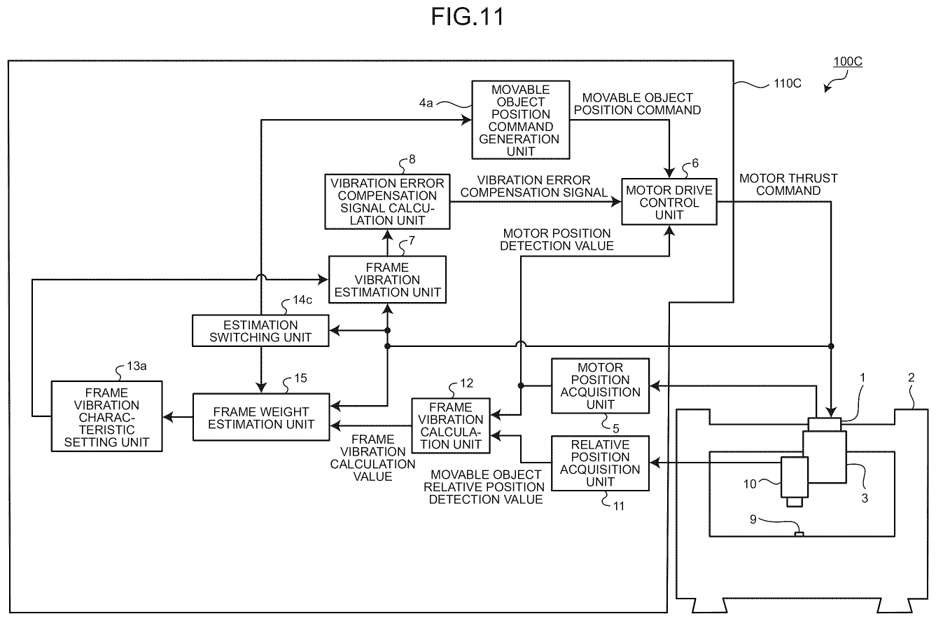

FIG. 11 is a diagram illustrating a configuration of a positioning apparatus 100C according to a fourth embodiment. The positioning apparatus 100C includes a motor controller 110C instead of the motor controller 110 of the positioning apparatus 100. The configuration of the motor controller 110C is a configuration in which a movable object position command generation unit 4a is included instead of the movable object position command generation unit 4, a frame vibration characteristic setting unit 13a is included instead of the frame vibration characteristic setting unit 13, an estimation switching unit 14c is included instead of the estimation switching unit 14, and the frame vibration frequency estimation unit 16 and the frame vibration damping coefficient estimation unit 17 are omitted. The other components denoted by the same reference numerals are the same as those of the motor controller 110 according to the first embodiment. Thus, the following mainly describes differences from the first embodiment, and omits descriptions of the same portions as those of the first embodiment.

The frame vibration characteristic setting unit 13a stores the frame vibration frequency estimate value ω and the frame vibration damping coefficient estimate value ζ set in advance, and stores the frame weight estimate value m calculated by the frame weight estimation unit 15.

Based on the motor thrust command, the estimation switching unit 14c determines a period during which the frame weight estimation unit 15 performs the operation of estimating the frame weight estimate value m, and determines switching of the movable object position command generated by the movable object position command generation unit 4a.

The movable object position command generation unit 4a generates the movable object position command to cause the motor 1 to accelerate or decelerate and stop in a travel distance within a range in which the target position 9 is included in an image captured by the camera 10. The movable object position command generation unit 4a outputs the generated movable object position command to the motor drive control unit 6. When the motor 1 moves according to this movable object position command, the target position 9 is always included in an image captured by the camera 10 during acceleration or deceleration of the motor 1. Therefore, it is possible to determine a period during which the frame weight estimation unit 15 estimates the frame weight estimate value m, without determining whether or not the target position 9 is included in an image captured by the camera 10. That is, the estimation switching unit 14c can determine a period during which the operation of estimating the frame weight estimate value m is performed, based only on whether or not the motor 1 is accelerating or decelerating, without determining whether or not the target position 9 is included in an image captured by the camera 10.

The frame vibration frequency estimate value ω and the frame vibration damping coefficient estimate value ζ stored in the frame vibration characteristic setting unit 13a can be values read by a user from the frame vibration calculation value.

As described above, according to the motor controller 110C of the fourth embodiment, the movable object position command generation unit 4a can generate the movable object position command to cause the motor 1 to accelerate or decelerate and stop within a range in which the target position 9 is included in a captured image. Consequently, it is possible to determine a period during which the frame weight estimation unit 15 performs the estimation operation without determining whether or not the target position 9 is included in an image captured by the camera 10, and it is possible to reduce the amount of calculation required for the estimation switching unit 14c to make the determination. Furthermore, according to the motor controller 110C, the frame vibration frequency estimate value ω and the frame vibration damping coefficient estimate value ζ are set in advance, and estimation calculation thereof is not performed, so that the amount of calculation can be reduced.

The configurations described in the above embodiments illustrate an example, and can be combined with another known art. The embodiments can be combined with each other. The configurations can be partly omitted or changed without departing from the gist.

### REFERENCE SIGNS LIST

1 motor; 2 apparatus frame; 3 movable object; 4, 4a movable object position command generation unit; 5 motor position acquisition unit; 6 motor drive control unit; 7, 7a frame vibration estimation unit; 8 vibration error compensation signal calculation unit; 9 target position; 10 camera; 11 relative position acquisition unit; 12 frame vibration calculation unit; 13, 13a frame vibration characteristic setting unit; 14, 14a, 14b, 14c estimation switching unit; 15 frame weight estimation unit; 16 frame vibration frequency estimation unit; 17 frame vibration damping coefficient estimation unit; 71 delay addition unit; 72, 74 frame vibration motion equation calculation unit; 73 error calculation unit; 75 error compensation calculation unit; 76 output switching unit; 90 processing circuitry; 91 control circuit; 92 processor; 93 memory; 100, 100A, 100B, 100C positioning apparatus; 110, 110A, 110B, 110C motor controller.

1. A motor controller to control, based on a motor thrust command, thrust generated by a motor to thereby stop a movable object at a predetermined position relative to a target position, the motor being mechanically connected to the movable object, the movable object being installed movably relative to an apparatus frame, the motor controller comprising:
movable object position command generation to generate a movable object position command to stop the movable object at the predetermined position relative to the target position;
a motor position receiver to acquire a motor position detection value that is a time waveform of a position coordinate of the motor;
frame vibration estimation circuitry to calculate a frame vibration estimate value obtained by estimating vibration of the apparatus frame, based on the thrust generated by the motor and a frame weight estimate value that is an estimated weight of the apparatus frame;
vibration error compensation signal calculation circuitry to calculate, based on the frame vibration estimate value, a vibration error compensation signal to reduce an error due to the vibration of the apparatus frame included in a relative position of the movable object relative to the target position;
motor drive control circuitry to generate the motor thrust command, based on the movable object position command, the motor position detection value, and the vibration error compensation signal;
relative position acquisition circuitry to acquire a movable object relative position detection value from an image captured by a camera to capture an image of the target position, the movable object relative position detection value being a time waveform of a position coordinate of the movable object relative to the target position;
frame vibration calculation circuitry to calculate a frame vibration calculation value from the movable object relative position detection value; and
frame weight estimation circuitry to calculate the frame weight estimate value obtained by estimating a weight of the apparatus frame from the frame vibration calculation value and the thrust generated by the motor, wherein
the frame vibration estimation circuitry calculates the frame vibration estimate value, using the frame weight estimate value estimated by the frame weight estimation circuitry.

2. The motor controller according to claim 1, further comprising
estimation switching circuitry to determine a period during which the frame weight estimation circuitry performs an estimation operation, based on the thrust generated by the motor.

3. The motor controller according to claim 2, wherein the estimation switching circuitry causes the frame weight estimation circuitry to perform the estimation operation during a period in which the motor is accelerating or decelerating to move the movable object.

4. The motor controller according to claim 2, further comprising:
frame vibration frequency estimation circuitry to calculate a frame vibration frequency estimate value obtained by estimating a frame vibration frequency from the frame vibration calculation value; and
frame vibration damping coefficient estimation circuitry to calculate a frame vibration damping coefficient estimate value obtained by estimating a frame vibration damping coefficient from the frame vibration calculation value, wherein
the frame vibration estimation circuitry calculates the frame vibration estimate value, based on the frame vibration frequency estimate value and the frame vibration damping coefficient estimate value, and
the estimation switching circuitry causes the frame vibration frequency estimation circuitry and the frame vibration damping coefficient estimation circuitry to perform estimation operations during a period in which the motor is neither accelerating nor decelerating.

5. The motor controller according to claim 2, wherein the estimation switching circuitry determines whether or not the target position is included in the image captured by the camera, and causes the frame weight estimation circuitry to perform the estimation operation during a period in which the target position is included in the captured image.

6. The motor controller according to claim 4, wherein the estimation switching circuitry determines whether or not the target position is included in the image captured by the camera, and causes the frame vibration frequency estimation circuitry and the frame vibration damping coefficient estimation circuitry to perform the estimation operations during a period in which the target position is included in the captured image.

7. The motor controller according to claim 1, wherein the frame vibration estimation circuitry calculates the frame vibration estimate value, based on the thrust generated by the motor and the frame vibration calculation value.

8. The motor controller according to claim 7, further comprising
estimation switching circuitry to determine whether or not the target position is included in the image captured by the camera, and cause the frame vibration estimation circuitry to calculate the frame vibration estimate value, based on the thrust generated by the motor and the frame vibration calculation value, during a period in which the target position is included in the captured image.

9. The motor controller according to claim 1, wherein the movable object position command generation circuitry generates the movable object position command to cause the motor to accelerate or decelerate and stop within a range in which the target position is included in the captured image.

10. A positioning apparatus comprising:
an apparatus frame;
a movable object installed movably relative to the apparatus frame;
a motor mechanically connected to the movable object;
a camera to capture an image of a target position;
movable object position command generation circuitry to generate a movable object position command to stop the movable object at a predetermined position relative to the target position;
a motor position receiver to acquire a motor position detection value that is a time waveform of a position coordinate of the motor;
frame vibration estimation circuitry to calculate a frame vibration estimate value obtained by estimating vibration of the apparatus frame, based on thrust generated by the motor and a frame weight that is a weight of the apparatus frame;
vibration error compensation signal calculation circuitry to calculate, based on the frame vibration estimate value, a vibration error compensation signal to reduce an error due to the vibration of the apparatus frame included in a relative position of the movable object relative to the target position;
motor drive control circuitry to generate a motor thrust command to control the thrust generated by the motor, based on the movable object position command, the motor position detection value, and the vibration error compensation signal;
relative position acquisition circuitry to acquire, from the image captured by the camera, a movable object relative position detection value that is a time waveform of a position coordinate of the movable object relative to the target position;
frame vibration calculation circuitry to calculate a frame vibration calculation value from the movable object relative position detection value; and
frame weight estimation circuitry to calculate a frame weight estimate value obtained by estimating the weight of the apparatus frame from the frame vibration calculation value and the thrust generated by the motor, wherein
the frame vibration estimation circuitry calculates the frame vibration estimate value, using the frame weight estimate value estimated by the frame weight estimation circuitry.

11. A motor control method for a motor controller to control, based on a motor thrust command, thrust generated by a motor to thereby stop a movable object at a predetermined position relative to a target position, the motor being mechanically connected to the movable object, the movable object being installed movably relative to an apparatus frame, the motor control method comprising:
acquiring a position coordinate of the movable object relative to the target position from a captured image of the target position, and calculating a frame vibration calculation value of vibration occurring in the apparatus frame;
calculating a frame weight estimate value obtained by estimating a weight of the apparatus frame from the frame vibration calculation value and the thrust generated by the motor;
estimating the vibration of the apparatus frame from the frame weight estimate value and the thrust generated by the motor; and
calculating a vibration error compensation signal to reduce an error due to the vibration of the apparatus frame included in a relative position of the movable object relative to the target position, and changing the motor thrust command based on the vibration error compensation signal.

12. The motor controller according to claim 3, further comprising:
frame vibration frequency estimation circuitry to calculate a frame vibration frequency estimate value obtained by estimating a frame vibration frequency from the frame vibration calculation value; and
frame vibration damping coefficient estimation circuitry to calculate a frame vibration damping coefficient estimate value obtained by estimating a frame vibration damping coefficient from the frame vibration calculation value, wherein
the frame vibration estimation circuitry calculates the frame vibration estimate value, based on the frame vibration frequency estimate value and the frame vibration damping coefficient estimate value, and
the estimation switching circuitry causes the frame vibration frequency estimation circuitry and the frame vibration damping coefficient estimation circuitry to perform estimation operations during a period in which the motor is neither accelerating nor decelerating.

13. The motor controller according to claim 3, wherein the estimation switching circuitry determines whether or not the target position is included in the image captured by the camera, and causes the frame weight estimation circuitry to perform the estimation operation during a period in which the target position is included in the captured image.
